(19) United States
(12) Patent Application Publication
(10) Pub. No.: US 2002/0105544 A1
(43) Pub. Date: Aug. 8, 2002

(54) Method for enhancing client side delivery of information

(75) Inventors: Steven Jay Lipton, Flower Mound, TX (US); Rick A. Hamilton II, Charlottesville, VA (US)

Correspondence Address: Cynthia S. Byrd, IBM Corporation, 11400 Burnet Rd., Austin, TX, 78758, US

(73) Assignee: INTERNATIONAL BUSINESS MACHINES CORPORATION, ARMONK, NY

(21) Appl. No.: 09/779,371

(22) Filed: Feb. 8, 2001

(51) Int. Cl. G06F 13/00

(52) U.S. Cl. 345/744; 345/745

(57) ABSTRACT

A system for and a method of enhancing information delivery to a client is disclosed. The client accesses an input file containing at least one record where each record comprises a URL, a time and a date for displaying the URL. The system time and date is verified and a first document is displayed at the client based on a first system time and date. A second document is displayed at the client based on a second system time and date. The second document can be different from or the same as the first document depending upon the preferences entered by the client.

### TECHNICAL FIELD

The present invention relates to a method for and a system of enhancing client side delivery of information. More particularly, the invention relates to a method of and system for delivering web content to a client system at defined times.

### BACKGROUND OF THE INVENTION

The Internet is a world wide communication network, enabling computer users to connect to other computer users. Users on local area computer networks are also interconnected via the Internet to send and receive information to other users on other local area computer networks. The world wide web is the multimedia portion of the Internet which provides full color graphics and sound.

Using the Internet and accessing the world wide web, has been made easier by the proliferation of web browser programs. A web browser is a software utility device which provides the user with a simple graphical user interface to navigate the Internet. With a web browser, the user can navigate through the Internet by selecting options from icons and menus with a point and click mouse. Typically, a web browser, upon initially connecting to the Internet, accesses and displays a specified document, often referred to as a “home page”.

The typical web browser includes a function that allows the user to specify a particular URL for the home page. When the web browser initially connects to the Internet, the web site associated with the selected URL is displayed. Likewise when the user selects the “home” button, the browser displays the default home page. Most users typically do not change the default home page setting.

When a user wants to mark or remember a particular URL for future reference, they typically copy the URL to their “bookmark” file or “favorites” file, depending upon the browser. In order to receive a desired web page, network users and in particular web browser users manually direct their web browsers to specific network sites either by selecting the corresponding bookmark or by entering the URL. This effort is time consuming and requires the user to remember which sites to display and when to display them. There currently is no way to automatically display information at times that are tailored by an individual user. A method and system that enables users to enter web sites to be displayed at given times would be very useful.

### SUMMARY OF THE INVENTION

The present invention provides a system for and a method of enhancing information delivery to a client system. The client accesses an input file containing at least one record wherein each record comprises a URL, a time and a date for displaying the URL. The system time and date is verified and a first document is displayed at the client based on a first system time and date. A second document is displayed at the client based on a second system time and date. The second document can be different from or the same as the first document depending upon the preferences entered by the client.

### BRIEF DESCRIPTION OF THE DRAWINGS

FIG. 1 is an example of a client-server data processing system suitable for use in the present invention;

FIG. 2 is a block diagram of components found on an exemplary client in accordance with the present invention;

FIG. 3 is a schematic diagram of a client computer system suitable for use in the present invention;

FIG. 4 is flow diagram of a process for creating a master input file in accordance with the present invention;

FIG. 5 is a flow diagram of a process for creating custom preferences files on a client in accordance with a preferred embodiment of the present invention;

FIG. 6 is a flow diagram of a process for creating schedule script files in accordance with the present invention; and

FIG. 7 is a flow diagram of a process for running a schedule script in accordance with a preferred embodiment of the present invention.

### DETAILED DESCRIPTION OF THE PREFERRED EMBODIMENT

The present invention is directed to a method for and a system of enhancing client side delivery of information at predetermined times. A user designates URL's they want displayed on a client system and the time they want each designated URL to be displayed. The designated URL's are displayed automatically at the appropriate times without any user intervention.

Initially, the user creates an entry having a URL, a time and a date they want the URL displayed. A custom preferences file is created for each entry. A program monitors the client system time and date and executes instructions directing a web browser to display the various URLs at the designated times. The term “date” is used herein to define a calendar day, week, month, quarter, year and any combination thereof. The term “time” is defined as a specified interval during a given date. It will be apparent to those of ordinary skill in the art that the time and date a particular document is displayed can be specified in a number of ways and achieve the same result described in the present invention.

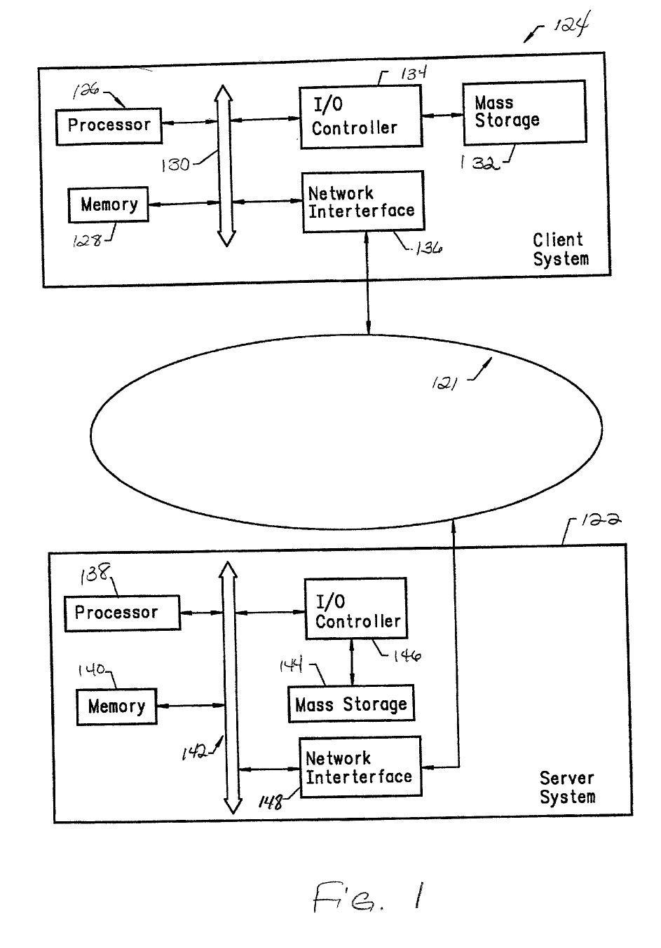

FIG. 1 depicts, an example of a client-server data processing system suitable for use in the present invention. In this example, a remote server system 122 is connected through the Internet 121 to client system 124. The client system 124 includes conventional components such as a processor 126, memory 128 (e.g. RAM), a bus 130 which couples the processor 126 and memory 128, a mass storage device 132 (e.g. a magnetic hard disk or an optical storage disk) coupled to the processor and memory through an I/O controller 134 and a network interface 136, such as a conventional modem.

The server system 122 also includes conventional components such as a processor 138, memory 140 (e.g. RAM), a bus 142 which couples the processor 138 and memory 140, a mass storage device 144 (e.g. a magnetic or optical disk) coupled to the processor 138 and memory 140 through an I/O controller 146 and a network interface 148, such as a conventional modem. It will be appreciated from the description below that the present invention may be implemented in software which is stored as executable instructions on a computer readable medium on the client and server systems, such as mass storage devices 132 and 144 respectively, or in memories 128 and 140 respectively. In addition, the executable instructions for use with the client system 124 may be stored on a floppy disk, or CD-ROM.

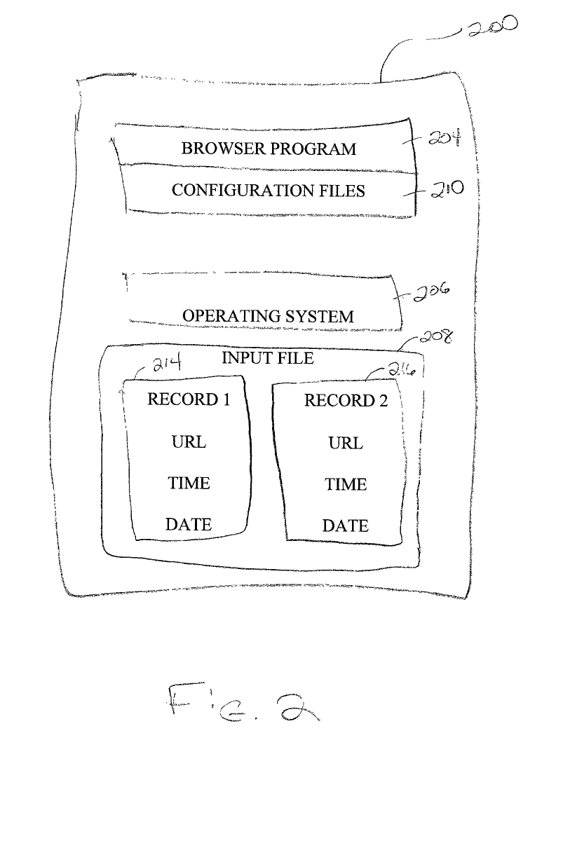

FIG. 2 is a block diagram of components found on an exemplary client in accordance with the present invention. The client system 200 as shown has a hard drive 202 containing a conventional web browser 204 such as Netscape Navigator, a registered trademark of Netscape Communications Corp. or Microsoft Internet Explorer, a registered trademark of Microsoft Corp., running on an operating system 206. The browser 204 is used to communicate requests over the network with the desired web server. In accordance with the present invention, a master input file 208 may reside either on the hard drive 202 or a CD-ROM or floppy that is read by the processor. The browser 204 contains standard preference files 210 that include general information regarding display properties and default home page information for a particular client. The browser 204 reads the preference files 210 at various time points and presents the proper home page information based on the then current time of day.

In one embodiment, when the browser is invoked, the system time and date are verified and the appropriate custom preferences file is copied to the preference file 210 in the browser directing the browser to display a specific web document. It should be noted that the present invention is easily adapted for use with existing browser software programs. In the alternative, newly developed browser programs may be written such that all the instructions for carrying out the present invention are included in the browser program.

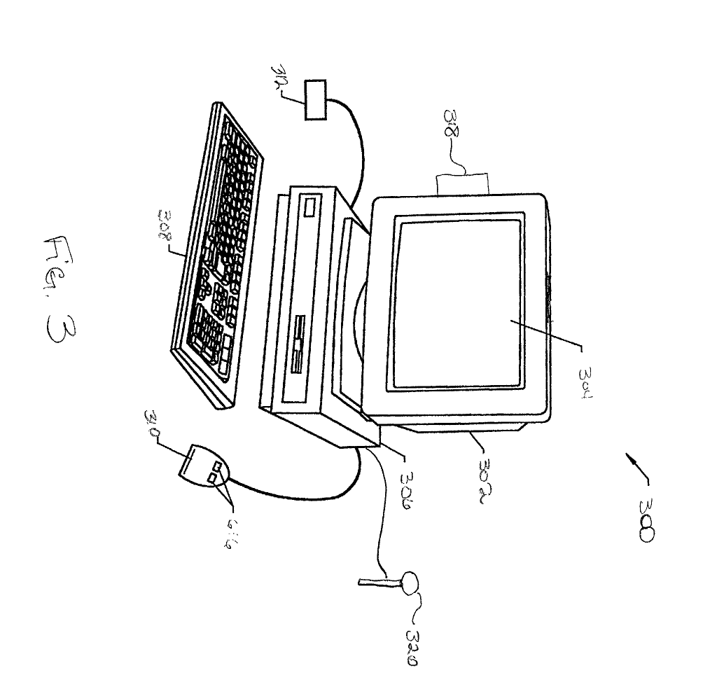

FIG. 3 is a schematic diagram of a client computer system 300 suitable for use in the present invention. The computer system 300 includes a display device 302 (such as a monitor), a display screen 304, a cabinet 306 (which encloses components typically found in a computer, such as CPU, RAM, ROM, video card, hard drive, sound card, serial ports, etc.), a keyboard 308, a mouse 310, a microphone 320 and a modem 312. Mouse 310 may have one or more buttons, such as buttons 316. The computer requires some type of communication device such as modem 312 that allows computer system 300 to be connected to the Internet. Other possible communication devices include ethernet network cards.

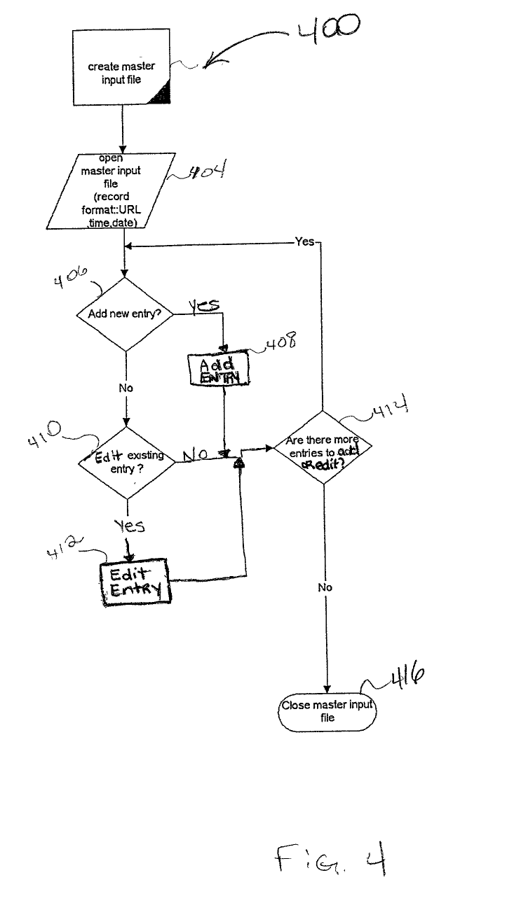

FIG. 4 is a flow diagram of a process 400 for creating a master input file in accordance with the present invention. The user creates a master input file containing at least one record, step 404. Each record contains a URL field, a time field and a date field. The user enters a URL, a time interval for displaying the URL and a date for displaying the URL. The user is queried as to whether they want to add or edit a record in the master input file, step 406. The term “edit” is used herein to mean update the fields in an existing record and/or delete an existing record. If the user answers “yes” at step 406, then the user is prompted to enter the appropriate information for the new record entry, step 408. If the user enters “no” at step 406, then the user is queried as to whether they want to edit an existing record, step 410. If the user wants to edit an entry, then they proceed with editing at step 412. When the user finishes adding and editing entries, they are queried as to if there are additional entries to add or edit, step 414. If the answer to step 414 is “yes” then the program cycles back to step 406 until all of the desired records are added and/or edited. When there are no more files to add and/or edit, the program closes the master input file and the process ends, step 416.

One example of a record format for displaying a given page on a particular day could be: [URL Day of Week Time of Day Day of Month Month]. If a user wanted to display the International Business Machines web page at 8AM every Monday the input file would look like: [www.ibm.com Monday 08:00 All All]. In this example, the IBM home page would be displayed at 8:00AM and remain displayed until the user selected another page or until a given time is reached matching another custom preferences file. Alternatively, a time interval of 08:00-10:00 could be entered for the time of day field such that the IBM home page would be displayed during the hours of 8AM and 10AM. If the user does not have a home page listed for display at 10AM, then the browser may display the default home page. One of ordinary skill in the art will be able to construct various time schemes without departing from the spirit of the present invention.

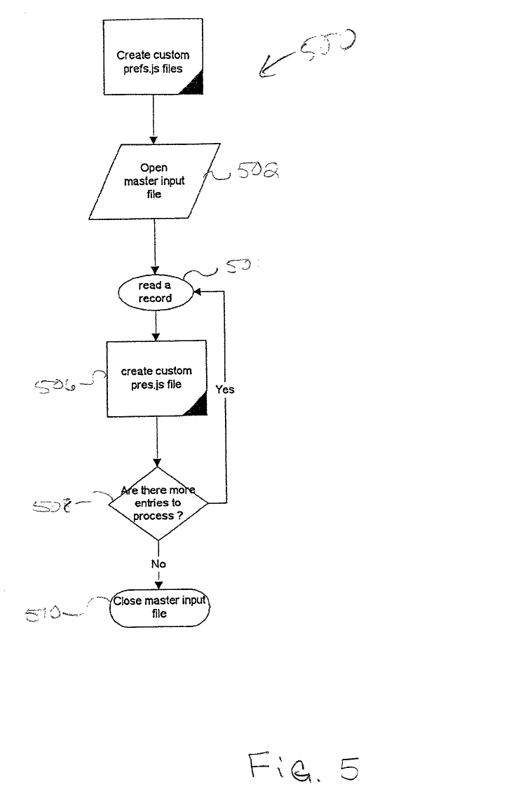

FIG. 5 is a flow diagram of a process 500 for creating custom preferences files at a client in accordance with a preferred embodiment of the present invention. The client executes a program containing instructions to open the master input file, step 502 and read the records in the master input file, step 504. The program writes the URL information present in a record into a custom preferences file unique for that particular record, step 506. Any remaining standard preference information regarding the user is also copied from the default preferences file into the custom preferences file. The program then checks for additional entries to process, step 508. If there are more entries, then the program cycles back to step 504. When custom preferences files are created for each record present in the master input file, the master input file is closed and the process ends, step 510.

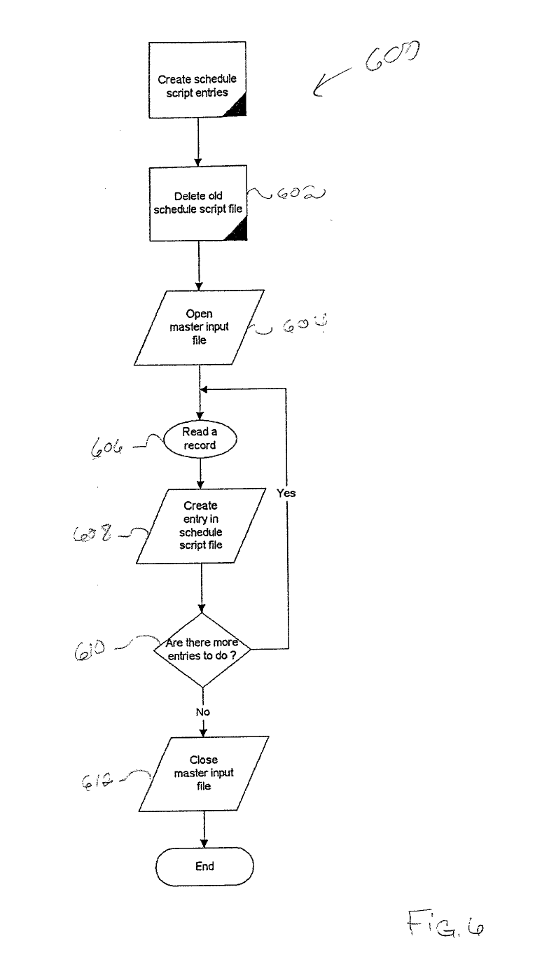

FIG. 6 is a flow diagram of a process 600 for creating schedule script files in accordance with the present invention. The client executes a program that deletes old or existing schedule script files, step 602. The program opens the master input file, step 604 and reads each record in the master input file, step 606. The program creates an entry in a new schedule script file in accordance with the time and date values present in a given record, step 608. The program checks whether there are more entries to be read, step 610. If there are more entries to be read, then the process cycles back to step 606. When schedule scripts are created for each record present in the master input file, the file is closed and the process ends, step 612.

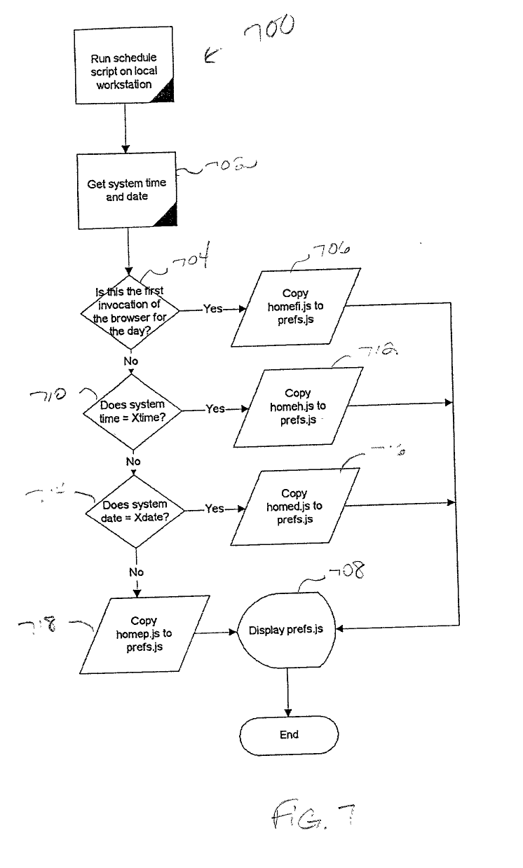

FIG. 7 is a flow diagram of a process 700 for running a schedule script on an enhanced web browser in accordance with a preferred embodiment of the present invention. In order to understand the flow diagram some basic terms are defined as follows: homeₚ=permanent home where only one home page is selected by the user; homed =home page selected for predefined days of any given month; homeₕ=home page displayed for predefined time periods of any given day; home_{fi}=home in the first instance of the day, triggered upon the first invocation of the browser on a given day.

When a browser on a client system is invoked the schedule script verifies the system time an date, 702. The script determines whether this is the first invocation of the browser for the day, 704. If yes, then the script copies the homefi.js to the prefs.js file resident in the browser 706. The browser displays the preferences associated with the homefi.js file, 708. If it is not the first invocation of the browser, then the script checks if the system time=X time where X corresponds to a time found in a specific custom preferences file, 710. If yes, then the program copies the homeh.js file to the prefs.js file, 712. The browser then displays the preferences associated with the homeh.js file, 708. If the system time does not equal X time, then the programs checks if the system date=X date, where X date corresponds to a date found in a specific custom preferences file, 714. If yes, then the browser copies the home_{d}.jsfile to the prefs.js file, 716. The browser then displays the preferences associated with the home_{d}.js file, 708. If the system date does not equal X date, then the script copies the homeₚ.js file to the prefsjs file which is the default home page, 718. The browser then displays the preferences associated with the homeₚ.js file. The schedule script may be set to run at periodic time intervals depending upon the needs of the user. As noted above, the present invention could be incorporated into a new browser package where the step of copying the information from the custom preferences file to the browser preferences file would not be necessary.

The present invention allows the user the flexibility to specify what home page is displayed at any given time during the day, week, month, quarter, year, or any time frame they choose. The desired web documents are automatically displayed in accordance with the user's preferences without any further user intervention. This is advantageous in that the user does not need to remember to access a given URL on a specific date, making information retrieval and review much easier.

While the invention has been shown and described with reference to particular embodiments thereof, it will be understood by those skilled in the art that the foregoing and other changes in form and detail may be made therein without departing from the spirit and scope of the invention.

1. A method of enhancing information delivery to a client system, the method comprising:
accessing, at the client, at least one configuration file comprising instructions for displaying a URL at a given time and date;
verifying the client system time and date;
displaying a first document at the client based on a first system time and date; and
displaying a second document at the client based on a second system time and date.

2. The method of claim 1 further comprising upon initial invocation of the web browser, displaying a third document independent of the system time and date;

3. The method of claim 1 further comprising creating, at the client, an input file containing at least one record wherein each record comprises a URL, a time and a date.

4. The method of claim 3 further comprising
creating a custom preferences file for each record based on information present in each record; and
copying the custom preferences file to a default preferences file associated with a browser on the client upon the occurrence of a given system time and date.

5. The method of claim 3 further comprising creating a schedule script file for each record in the input file.

6. The method of claim 5 further comprising running a schedule script periodically and identifying custom preferences files having a date and time that corresponds to the current system date and time.

7. A system for customizing content delivery to a client comprising:
a processor;
a memory coupled to the processor;
a computer readable medium coupled to the processor containing instructions for:
accessing, at the client, at least one configuration file comprising instructions for
displaying a URL at a given time and date;
verifying the client system time and date;
displaying a first document at the client based on a first system time and date; and
displaying a second document at the client based on a second system time and date.

8. The system of claim 7 wherein the instructions further comprise upon initial invocation of the web browser, displaying a third document independent of the system time and date;

9. The system of claim 7 wherein the instructions further comprise creating, at the client, an input file containing at least one record wherein each record comprises a URL, a time and a date.

10. The system of claim 7 wherein the instructions further comprise
creating a custom preferences file for each record; and
copying the custom preferences file to a default preferences file associated with a browser on the client upon the occurrence of a given system time and date.

11. The system of claim 9 wherein the instructions further comprise creating a schedule script file for each record in the input file.

12. The system of claim 11 further comprising running a schedule script periodically; and identifying custom preferences files having a date and time that corresponds to the current system date and time.

13. A computer readable medium on a client system containing executable program instructions for performing a method comprising:
accessing, at the client, at least one configuration file comprising instructions for displaying a URL at a given time and date;
verifying a client system time and date;
displaying a first document, at the client, based on a first system time and date; and
displaying a second document, at the client, based on a second system time and date.

14. The computer readable medium of claim 13 further comprising upon initial invocation of the web browser, displaying a third document independent of the system time and date;

15. The computer readable medium of claim 13 further comprising creating, at the client, an input file containing at least one record wherein each record comprises a URL, a time and a date.

16. The computer readable medium of claim 15 further comprising creating a custom preferences file for each record; and
copying the custom preferences file associated with a browser on the client upon the occurrence of a given system time and date.

17. The computer readable medium of claim 15 further comprising creating a schedule script file for each record in the input file.

18. The computer readable medium of claim 17 further comprising running a schedule script periodically; and identifying custom preferences files having a date and time that corresponds to the current system date and time.
